(19) United States
(12) Patent Application Publication
(10) Pub. No.: US 2015/0128423 A1
(43) Pub. Date: May 14, 2015

(54) SCISSORS APPARATUS FOR SPECIAL SNIPPING

(71) Applicant: BNR Development, LLC, Burlington, WI (US)

(72) Inventor: Robert Riggs, Burlington, WI (US)

(73) Assignee: BNR DEVELOPMENT, LLC, Burlington, WI (US)

(21) Appl. No.: 14/536,023

(22) Filed: Nov. 7, 2014

Related U.S. Application Data
(60) Provisional application No. 61/901,763, filed on Nov. 8, 2013.

(51) Int. Cl. B26B 13/06

(52) U.S. Cl. CPC B26B 13/06
USPC 30/29.5; 30/257

(57) ABSTRACT

Scissors apparatus in which each of the two blade sections includes (1) a blade first subsection adjacent the pivot axis of the scissors, the two first subsections being pivotally movable with respect to one another in a primary shearing plane for cutting thereacross the primary shearing plane, and (2) a blade second subsection, the two second subsections being movable in a secondary shearing plane angled, preferably at 90 degrees, with respect to the primary shearing plane for cutting across the secondary shearing plane. The second subsections preferably being configured and dimensioned for particular uses, such as in-nostril cutting of hair.

### FIELD OF THE INVENTION

This invention relates generally to scissors and, more particularly, to scissors apparatus for cutting in difficult places or at difficult angles.

### BACKGROUND OF THE INVENTION

A wide variety of scissors have been developed for various specialized purposes, such as for cutting in difficult or somewhat inaccessible places, cutting at difficult angles, or cutting at places where accurate cutting is difficult for a variety of reasons.

The use of various sorts of existing scissors often poses problems or drawbacks when applied to certain difficult cutting tasks. One example relates to clipping hair in nostrils, ears and the like, where clipping of hair is often desirable for aesthetic or health reasons. Users can easily tend to over insert the scissors blades and risk injury or discomfort, or the cutting blades can be at improper angles for proper cutting. Or in some cases the blades may be of sizes such that cutting, or at least thorough and accurate cutting, is difficult.

A wide variety of other situations involving cutting pose difficulties when using various sorts of existing scissors. For example, in some situations the use of existing scissors, even specialized scissors, may be inconvenient or difficult in various sewing or garment-related tasks. Another example involves the art of fly-tying to create “flies” for fly-fishing purposes. Fly tiers combine the use of fine materials and strands with intricate and complex motions, snips and the like to result in their creations aimed at attracting fish, and because of inaccessibility and angle issues, existing cutting tools sometimes pose particular problems and drawbacks. A myriad of other situations involving fine specialized cutting are not fully satisfied using existing specialized cutting implements.

### OBJECTS OF THE INVENTION

It is an object of the invention to provide improved scissors apparatus for cutting in difficult or somewhat inaccessible places, cutting at difficult angles, or cutting at places where accurate cutting is difficult for a variety of reasons.

Another object of this invention is to provide improved scissors apparatus overcoming the problems referred to above.

One particular object of this invention is to provide cutting apparatus for uses such as clipping of hair in human nostrils, ears and the like, an easy-to-use nose hair trimmer which can be safely inserted into a human nostril to an appropriate depth.

Another object of this invention is to provide cutting apparatus for wide variety of specialized cutting applications.

How these and other objects are accomplished will become apparent from the following descriptions and the drawings.

### BRIEF SUMMARY OF THE INVENTION

This invention is an improvement in scissors apparatus of the type including first and second members movable in a primary shearing plane about a pivot axis normal to the primary shearing plane, the movable members each having a handle section and a blade section.

In the inventive scissors apparatus, the blade sections of each of the first and second members includes (1) a first subsection proximal to the pivot axis, the two first subsections (i.e., the first subsections of the first and second members) are pivotally movable with respect to one another in the primary shearing plane for cutting across the primary shearing plane, and (2) a second subsection distal from the pivot axis, the two second subsections (i.e., the second subsections of the first and second members) are movable in a secondary shearing plane angled with respect to the primary shearing plane for cutting across the secondary shearing plane. During closing motion of the first and second movable members, progressive shearing action first occurs between the first subsections in the primary shearing plane and then progressive shearing action occurs between the second subsections in the secondary shearing plane.

In preferred embodiments, the secondary shearing plane is at an angle of at least about 45 degrees with respect to the primary shearing plane. Most preferably, the secondary shearing plane is substantially normal to the primary shearing plane.

In preferred embodiments, the second subsections are shorter than the first subsections. Preferably, when the inventive scissor apparatus is intended for use in snipping nostril hair, the length of each of the second subsections is no more than about one-third the length of the first subsections and most preferably, the length of each of the second subsections is less than the depth of the adult human nostril.

Each of the second subsections has an outer edge, and it is preferred that the distance between the outer edges of the second subsections when the second subsections are open sufficiently for the beginning of their shearing motion (i.e., the distance with the blade edges open before the cutting motion), be less than the width of the adult human nostril for those situations in which the inventive scissors apparatus are used for snipping nostril hair. This facilitates shearing motions within the adult human nostril.

More generally, in certain preferred embodiments of this invention the length of the second subsection is no more than about 0.5 inch. And it is preferred that the second subsections be configured such that distance between their outer edges when the second subsections are open sufficiently for the beginning of their shearing motion be no more than about 0.25 inch.

Movement of the second subsections of the blade sections toward one another terminates when the two handle portions meet one another. This, of course, prevents the second subsections of the blade sections from moving beyond an overlapping position with respect to one another when the shearing action ends.

For a wide variety of intended uses of the scissors apparatus of this invention, it is highly preferred that the second subsections be tapered such that they are narrowest at the tips thereof. And in such embodiments it is preferred that each of the outer edges be concave between the first subsection and the tip. The tips of the second subsections are preferably blunt to prevent any accidental piercing during uses involving the human body. The exact sizing and configuration of blade subsections can be chosen to maximize effectiveness of the inventive scissors depending on the particular intended use.

In another aspect of this invention, it is not necessary that there be shearing action between the first subsections of the first and second movable members. In other words, the first and second members of the scissors apparatus which are movable in a primary plane about a pivot axis normal to the primary plane each have sections which can be referred to as a handle section and a beyond-pivot section.

More specifically, each of the beyond-pivot sections includes (1) a first subsection proximal to the pivot axis, the two first subsections being pivotally movable with respect to one another in the primary plane between open and closed (converged) positions, and (2) a second subsection distal from the pivot axis, the two second subsections (i.e., the second subsections of the first and second members) being blades movable in a secondary plane angled with respect to the primary plane for cutting across the secondary plane. During closing motion of the first and second movable members, after the first and second subsections have converged, progressive shearing action occurs between the second subsections (i.e., the blades) in the secondary plane.

### BRIEF DESCRIPTION OF THE DRAWINGS

FIG. 1 is a perspective view of the scissors apparatus of this invention in a fully-closed position.

FIG. 2 is a perspective view of the scissors in a partially-open position with respect to the primary shearing plane and a fully-open position with respect to the secondary shearing plane.

FIG. 3 is a side elevation of the scissors.

FIG. 4A is another perspective view of the scissors showing the first subsections in mid-shearing positions with respect to the primary shearing plane and the second subsections approaching one another in the secondary shearing plane.

FIG. 4B is a perspective view showing the scissors after completion of shearing action of the first subsections along the primary shearing plane and with the second subsections in mid-shearing positions in the secondary shearing plane.

FIG. 4C is a perspective view of the scissors upon completion of the shearing action of second subsections in the secondary shearing plane, i.e., with the movable members in a fully-closed position.

### DETAILED DESCRIPTION OF PREFERRED EMBODIMENTS

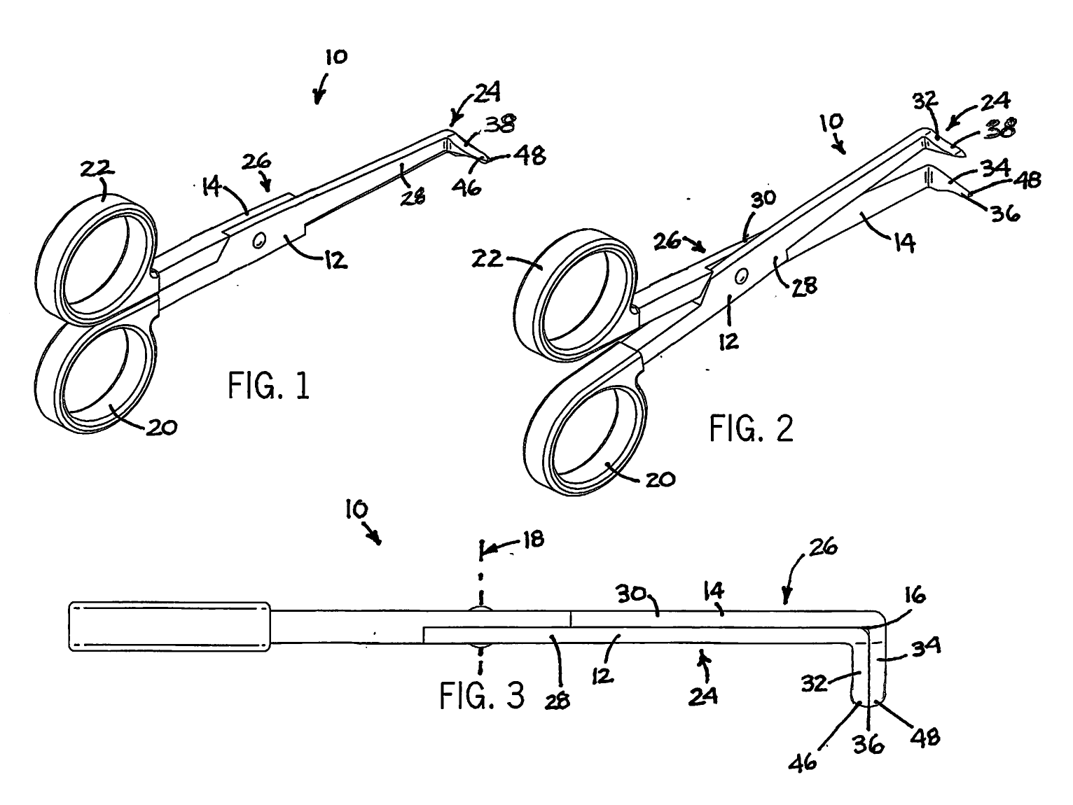

As seen in FIGS. 1-3 and all the figures, scissors apparatus 10 of the present invention includes first and second members 12 and 14. First and second member 12 and 14 are movable with respect to one another about a pivot axis 18 (see FIG. 3). Movable members 12 and 14 have handle sections 20 and 22, respectively, and blade sections 24 and 26, respectively.

Blade sections 24 and 26 have respective first subsections 28 and 30 which are proximal to pivot axis 18. First subsections 28 and 30 are pivotally movable with respect to one another in a primary shearing plane which is indicated by the location of numeral 16, for cutting across primary shearing plane 16. Pivot axis 18 is normal to primary shearing plane 16. As seen in all the figures but perhaps best illustrated in FIG. 3, blade sections 24 and 26 further include respective second subsection 32 and 34 which are distal from pivot axis 18. Second subsections 32 and 34 are movable in a secondary shearing plane, which is indicated by number 36, for cutting across secondary shearing plane 36. Secondary shearing plane 36 is normal to primary shearing plane 16; i.e., it is at 90 degrees with respect thereto.

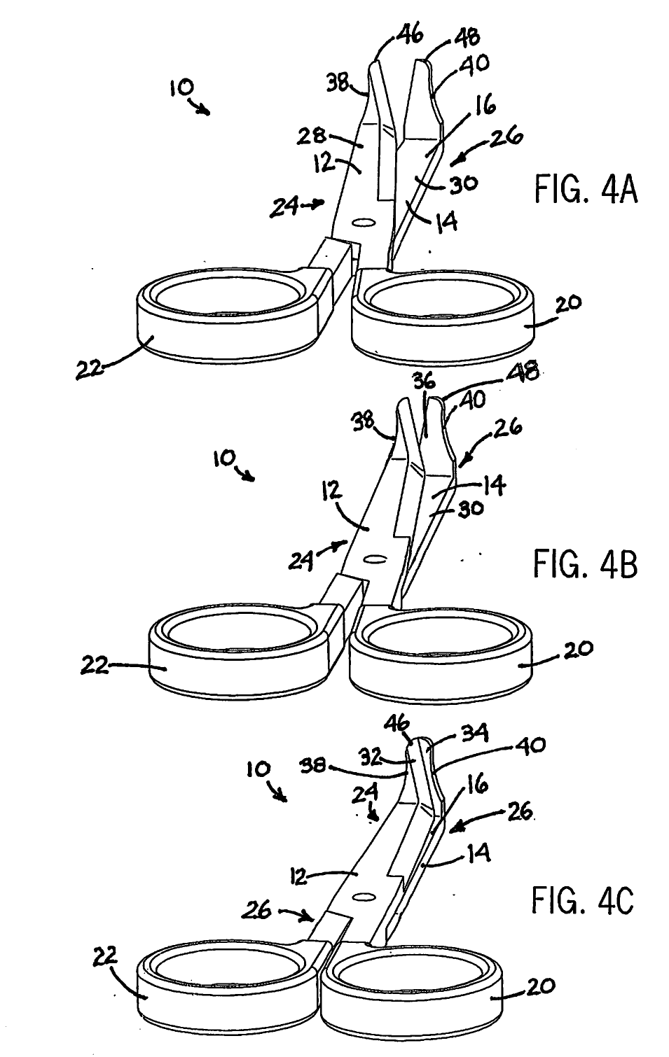

FIGS. 4A-4C illustrate various stages of the closing/cutting motion of first and second movable members 12 and 14. Progressive shearing action first occurs in primary shearing plane 16 by the converging movements of blade first subsections 28 and 30, allowing cutting across primary shearing plane 16. This is illustrated by FIG. 4A. Then, after further closing motion of relatively-movable members 12 and 14, shearing action in secondary shearing plane 36 occurs between blade second subsections 32 and 34, allowing cutting across secondary shearing plane 36. This is illustrated by FIG. 4B. Completion of shearing action in secondary shearing plane 36 is illustrated by FIG. 4C.

As can be seen, second subsections 32 and 34 have lengths of about one-third the lengths of first subsections 28 and 30. The dimensions of the blade second subsections 32 and 34 are chosen depending on the particular task intended. More specifically, if the scissors apparatus is intended for use in adult human nostrils, then the hair-growing depth of the typical adult human nostril is a useful guide Likewise, the widths of second subsections 32 and 34 are chosen such that scissors 10 can be used within the constraints of the nostril opening.

As best seen in FIGS. 4A-4C, second subsections 32 and 34 include outer edges 38 and 40 which are concave tapers, and such tapers lead to tips which are narrow tips, which facilitate use and aid viewing during use. Instead of the tapered outer edges 38 and 40 being concave, the tapered edges may be straight. Second subsections 32 and 34 terminate in tips 46 and 48 which are blunt enough to avoid piercing of human tissue such as inside human nostrils. (See FIGS. 3 and 4A-4C.)

Reference throughout this specification to “one embodiment,” “an embodiment,” “a preferred embodiment,” “alternate embodiment” or similar language means that a particular feature, structure, or characteristic described in connection with the embodiment is included in at least one embodiment of the present invention. Thus, appearances of the phrases “in one embodiment,” “in an embodiment,” “in a preferred embodiment,” “in an alternate embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the principles of the invention may be practiced without one or more of the specific features or advantages of a particular embodiment. In other instances, additional features and advantages may be recognized in certain embodiments that may not be present in all embodiments of the invention.

While the principles of the present invention have been described in connection with certain exemplary, alternate or specific embodiments, it is to be understood that such are by way of example only and are not limiting. The principles of the invention are not limited to the disclosed embodiments, but, on the contrary, are intended to cover various modifications, alternatives, modifications and equivalent arrangements as will be apparent to those skilled in the art. Any such changes, modifications, alternatives, modifications, equivalents and the like may be made without departing from the spirit and scope of the principles disclosed.

What is claimed is:

1. In scissors apparatus including first and second members movable in a primary shearing plane about a pivot axis normal to the primary shearing plane, the movable members each having a handle section and a blade section, the improvement wherein each of the blade sections includes:
a first subsection proximal to the pivot axis, the two first subsections pivotally movable with respect to one another in the primary shearing plane for cutting across the primary shearing plane; and
a second subsection distal from the pivot axis, the two second subsections movable in a secondary shearing plane angled with respect to the primary shearing plane for cutting across the secondary shearing plane,
whereby, during closing motion of the first and second movable members, progressive shearing action first occurs between the first subsections in the primary shearing plane and then progressive shearing action occurs between the second subsections in the secondary shearing plane.

2. The scissors apparatus of claim 1 wherein each of the second subsections is shorter than each the first subsections.

3. The scissors apparatus of claim 2 wherein the length of each of the second subsections is no more than about one-third the length of the first subsections.

4. The scissors apparatus of claim 3 wherein the length of each of the second subsections is less than the depth of the adult human nostril.

5. The scissors apparatus of claim 3 wherein each of the second subsections has an outer edge and the distance between the outer edges of the second subsections when the second subsections are open sufficiently for the beginning of their shearing motion is less than the width of the adult human nostril.

6. The scissors apparatus of claim 5 wherein the second subsections each include a tip and are tapered to be narrowest at the tips thereof.

7. The scissors apparatus of claim 6 wherein each of the outer edges is concave between the first subsection and the tip.

8. The scissors apparatus of claim 6 wherein the second subsections have blunt tips.

9. The scissors apparatus of claim 1 wherein the secondary shearing plane is at an angle of at least about 45 degrees with respect to the primary shearing plane.

10. The scissors apparatus of claim 9 wherein the secondary shearing plane is substantially normal to the primary shearing plane.

11. The scissors apparatus of claim 1 wherein at least one of the handle sections has a cooperating stop such that the second subsections are prevented from moving substantially beyond overlap with one another after shearing motion thereof.

12. The scissors apparatus of claim 3 wherein the length of the second subsections is no more than about 0.5 inch.

13. The scissors apparatus of claim 12 wherein each of the second subsections has an outer edge and the distance between the outer edges of the second subsections when the second subsections are open sufficiently for the beginning of their shearing motion is no more than about 0.25 inch.

14. In scissors apparatus including first and second members movable in a primary plane about a pivot axis normal to the primary plane, the movable members each having a handle section and a beyond-pivot section, the improvement wherein each of the beyond-pivot sections includes:
a first subsection proximal to the pivot axis, the two first subsections pivotally movable with respect to one another in the primary plane; and
a second subsection distal from the pivot axis, the two second subsections being blades movable in a secondary plane angled with respect to the primary plane for cutting across the secondary plane,
whereby, during closing motion of the first and second movable members, after the first and second subsections have converged progressive shearing action occurs in the secondary plane.

15. The scissors apparatus of claim 14 wherein the secondary plane is at an angle of at least about 45 degrees with respect to the primary plane.

16. The scissors apparatus of claim 15 wherein the secondary plane is substantially normal to the primary plane.

17. The scissors apparatus of claim 14 wherein the length of the blades is no more than about 0.5 inch.

18. The scissors apparatus of claim 17 wherein each of the second subsections has an outer edge and the distance between the outer edges of the second subsections when the second subsections are open sufficiently for the beginning of their shearing motion is no more than about 0.25 inch.

19. The scissors apparatus of claim 18 wherein the second subsections are tapered to be narrowest at the tips thereof.

20. The scissors apparatus of claim 19 wherein each of the outer edges is concave between the first subsection and the tip.
